(19) United States
(12) Patent Application Publication
(10) Pub. No.: US 2022/0068533 A1
(43) Pub. Date: Mar. 3, 2022

(54) Systems and Methods for a Self-Shorting Bi-Stable Solenoid

(71) Applicant: HUSCO Automotive Holdings LLC, Waukesha, WI (US)

(72) Inventors: Trevor Wynkoop, Milwaukee, WI (US); Matthew Pellmann, Summit, WI (US)

(21) Appl. No.: 17/461,776

(22) Filed: Aug. 30, 2021

Related U.S. Application Data
(60) Provisional application No. 63/071,454, filed on Aug. 28, 2020.

(51) Int. Cl. H01F 7/08; H01F 7/16; H01F 7/128; H01F 7/02

(52) U.S. Cl. CPC H01F 7/081; H01F 7/16; H01F 2007/086; H01F 7/02; H01F 7/128

(57) ABSTRACT

A bi-stable solenoid includes a housing, a wire coil arranged within the housing, a first pole piece, a second pole piece, an armature slidably arranged within the housing, and a permanent magnet arranged within the armature between a first armature portion and a second armature portion. The first armature portion and the second armature portion are fabricated from a magnetically permeable material. Selective energization of the wire coil generates a wire coil flux path and is configured to move the armature between the first stable position and the second stable position. The first stable position is established by magnetic flux of the permanent magnet shorting through the first pole piece, and the second stable position is established by the magnetic flux of the permanent magnet traversing the wire coil flux path.

### CROSS-REFERENCES TO RELATED APPLICATIONS

This application is based on and claims priority to U.S. Provisional Patent Application No. 63/071,454, filed on Aug. 28, 2020, which is incorporated herein by reference in its entirety.

### STATEMENT REGARDING FEDERALLY SPONSORED RESEARCH

Not Applicable.

### BACKGROUND

Bi-stable solenoid typically include a wire coil arranged around a movable armature. When a current is applied to the wire coil, a magnetic field is generated that can then actuate (i.e., move) the movable armature from a first position to a second position. In general, an armature within a bi-stable solenoid is movable between two stable positions. For example, a current may be applied to the wire coil in a first direction with a magnitude sufficient to actuate an armature from a first position to a second position. The armature may remain in the second position until a current is applied to the wire coil in a second direction with a magnitude sufficient to actuate the armature from the second position back to the first position.

### SUMMARY OF THE INVENTION

The present disclosure provides a bi-stable solenoid that includes an armature, a first pole piece, and a second pole piece and is configured to move between a first position and a second position. In the first position, the armature is secured by a magnetic detent, and in the second position, the armature engages the second pole piece and is secured by a magnetic latch.

In one aspect, the present disclosure provides a bi-stable solenoid that includes a housing defining a first end and an opposing second end, a wire coil arranged within the housing, a first pole piece adjacent the first end of the housing, a second pole piece adjacent the second end of the housing, an armature slidably arranged within the housing and movable between a first stable position and a second stable position, and a permanent magnet arranged within the armature between a first armature portion and a second armature portion. The first armature portion and the second armature portion are fabricated from a magnetically permeable material. Selective energization of the wire coil generates a wire coil flux path and is configured to move the armature between the first stable position and the second stable position. The first stable position is established by magnetic flux of the permanent magnet shorting through the first pole piece, and the second stable position is established by the magnetic flux of the permanent magnet traversing the wire coil flux path.

In one aspect, the present disclosure provides a bi-stable solenoid that includes a housing, a wire coil arranged within the housing, a first pole piece, a second pole piece, an armature including a permanent magnetic, and an armature tube at least partially encloses the armature and includes a stop surface. The armature is movable between a first stable position and a second stable position. When the armature is in the first stable position and the wire coil is de-energized, the armature engages the stop surface and a flux of the permanent magnet shorts through the first pole piece by forming a closed loop flux path that travels through the armature, the permanent magnet, and the first pole piece. The stop surface holds the armature in an axial location where the closed loop flux path generates a force on the armature in a direction that urges the armature into the stop surface.

In one aspect, the present disclosure provides bi-stable solenoid that includes a housing, a wire coil arranged within the housing, a first pole piece, a second pole piece, an armature including a permanent magnet, and an armature tube at least partially enclosing the armature and including a stop surface. Selective energization of the wire coil is configured to move the armature between the first position and the second position. When the armature is in the first position, flux of the permanent magnet shorts through the first pole piece to establish a magnetic detent, and when the armature is in the second position, the flux of the permanent magnet maintains the armature in the second position with a magnetic latch established by engagement between the armature and the second pole piece. The stop surface holds the armature in an axial location where the magnetic detent generates a force on the armature in an axial direction away from the second pole piece.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic illustration of a bi-stable solenoid in a first position according to one aspect of the present disclosure;

FIG. 2 is a schematic illustration of the bi-stable solenoid of FIG. 1 in a second position;

FIG. 3 is a graph illustrating an armature force as a function of stroke for the bi-stable solenoid of FIG. 1 at various current magnitudes and polarities;

FIG. 4 is a schematic illustration of a magnetic detent flux path of the bi-stable solenoid of FIG. 1;

FIG. 5 is a graph illustrating an armature force as a function of stroke for the magnetic detent of FIG. 4;

FIG. 6 is a schematic illustration of a bi-stable solenoid in a first position according to another aspect of the present disclosure;

FIG. 7 is a schematic illustration of the bi-stable solenoid of FIG. 6 in a mid-position;

FIG. 8 is a schematic illustration of the bi-stable solenoid of FIG. 6 in a second position; and

FIG. 9 is a graph illustrated an armature force as a function of stroke for the solenoid of FIG. 6 at various current magnitudes and polarities.

### DETAILED DESCRIPTION OF THE INVENTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use herein of the term “axial” and variations thereof refers to a direction that extends generally along an axis of symmetry, a central axis, or an elongate direction of a particular component or system. For example, an axially-extending structure of a component may extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference or periphery of an object, around an axis of symmetry, around a central axis, or around an elongate direction of a particular component or system.

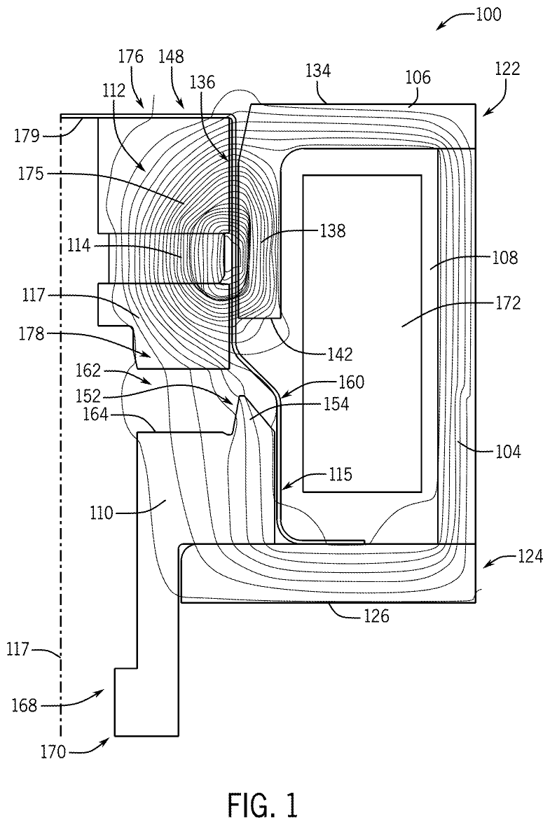

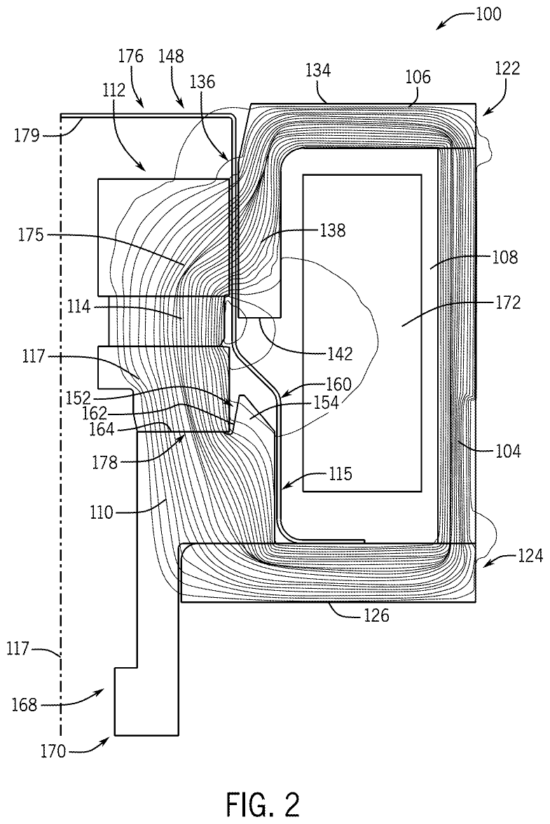

With reference to FIG. 1, a bi-stable solenoid 100 according to one non-limiting example of the present disclosure is shown. The bi-stable solenoid 100 can include a housing 104, a first pole piece 106, a bobbin 108, a second pole piece 110, an armature 112, a permanent magnet 114, and an armature tube 115. In the illustrated non-limiting example, the first pole piece 106, the bobbin 108, the second pole piece 110, the armature 112, the permanent magnet 114, and the armature tube 115 may be concentrically arranged along a central axis 117. For example, although only half of the bi-stable solenoid 100 is illustrated in FIGS. 1 and 2, the components thereof define axial symmetry around the central axis 117.

The housing 104 at least partially envelopes the first pole piece 106, the bobbin 108, the second pole piece 110, the armature 112, the permanent magnet 114, and the armature tube 115. Preferably, the permanent magnet 114 is disposed on, connected to, or included in the armature 112, so that the permanent magnet 114 moves with the armature 112. As will be described herein, the bi-stable solenoid arrangement according to aspects of the present disclosure may modify flux paths of the permanent magnet 114 to establish stable positions of an armature. For example, the bi-stable solenoid 100 may include one stable position formed by a magnetic latch and another stable position formed by a magnetic detent.

In the illustrated non-limiting example, the housing 104 can define a generally hollow, cylindrical shape and can include a generally open first end 122 and an opposing, generally open second end 124. The bi-stable solenoid 100 can also include a mounting base 126 coupled to the housing 104 proximate the open second end 124. The mounting base 126 can at least partially cover the open second end 124, thereby creating a partially enclosed chamber within the housing 104.

In some non-limiting examples, the armature 112 of the bi-stable solenoid 100 may be coupled to an actuation element (e.g., a pin, pushrod, etc.). The armature 112 may be configured to selectively displace the actuation element. It will be understood to those skilled in the art that the bi-stable solenoid 100, including the armature 112, can be used in any suitable arrangement to provide an actuation force and/or displacement to a device. For example, the armature 112 may be actuated to engage, either directly or indirectly, an actuation element to apply an actuation force and/or displacement thereto.

The first pole piece 106 can be fabricated from a magnetic material (e.g., magnetic steel, iron, nickel, etc.). The first pole piece 106 can be disposed at least partially within the housing 104 adjacent the first end 122 of the housing 104. As illustrated in FIG. 1, the first pole piece 106 can include a first surface 134 that extends radially inwardly from proximate a periphery of the housing 104. Further, the first pole piece 106 may include a first portion 136 in the form of a first axial projection 138 extending away from the first end 122 of the housing 104 toward the second end 124. The first portion 136 may axially extend from the first surface 134 of the first pole piece 106 to a free end 142.

Still referring to FIG. 1, the second pole piece 110 can similarly be fabricated from a magnetic material, such as, e.g., magnetic steel, iron, nickel, etc. The second pole piece 110 can be disposed partially within the housing 104 and axially separated from the first pole piece 106. The second pole piece 110 can extend at least partially through the mounting base 126 and be coupled to the mounting base 126. The second pole piece 110 can also include a second portion 152 that is configured to receive the armature 112. In the illustrated non-limiting example, the second portion 152 is in the form of a choke portion 154 extending away from an engagement surface 164 toward the first end 122 of the housing 104. More specifically, the second portion 152 can be an annular projection that is disposed at a first end 160 of the second pole piece 110, and can define an armature-receiving recess 162 configured to receive the armature 112. As illustrated in FIG. 2, the choke portion 154 and the engagement surface 164 together may define the armature-receiving recess 162. The engagement surface 164 of the armature-receiving recess 162 can act as an end stop for the armature 112. In addition, the second pole piece 110 can include a pin-engaging aperture 168. The pin-engaging aperture 168 can extend through a second end 170 of the second pole piece 110, and can be configured to slidably receive the actuation element (not shown) therethrough.

The bobbin 108 may be disposed within the housing 104 between the first pole piece 106 and the second pole piece 110. The bobbin 108 can be generally annular in shape and can enclose a wire coil 172.

The armature 112 can be fabricated from a magnetic material (e.g., magnetic steel, iron, nickel, etc.). The armature 112 can include a first end 176 and a second end 178. In some non-limiting examples, the armature 112 may additionally define a central aperture that is configured to receive an actuation element, such as, e.g., a pin, therethrough.

The permanent magnet 114 can be disposed within, connected to, or arranged on the armature 112. The permanent magnet 114 thus may be configured to move with the armature 112. In the illustrated non-limiting example, the permanent magnet 114 is disposed axially between the first end 176 and the second end 178 of the armature 112 and is axially magnetized (i.e., the north and south poles align with the central axis 117). In the illustrated non-limiting example, the permanent magnet 114 may be arranged axially between two portions of the armature 112. For example, the armature 112 may include a first armature portion 175 and a second armature portion 177 that are axially separated by the permanent magnet 114. The first armature portion 175 and the second armature portion 177 are fabricated from a magnetically permeable material (e.g., magnetic steel, iron, nickel, or equivalents). In general, the inclusion of the permanent magnet 114 between two magnetically permeable portions (i.e., the first armature portion 175 and the second armature portion 177) to form the armature 112 generates a higher output (force vs stroke), when compared to a design that forms an armature solely from a permanent magnet. In the illustrated non-limiting example, a surface of the permanent magnet 114 may be radially recessed relative to a surface of the armature 112. In other words, a radial thickness of the permanent magnet 114 may be less than the greatest radial thickness defined by the first armature portion 175 and the second armature portion 177.

The armature tube 115 is a thin-walled tube that encloses the armature 112 and at least partially encloses the second pole piece 110. The armature tube 115 may be fabricated from a non-magnetic material. The armature tube 115 includes a stop surface 179 adjacent to an axial location of the first surface 134 of the first pole piece 106. In general, an axial location of the stop surface 179 defines, and is configured to maintain, a first stable position of the armature 112 as will be described herein.

One non-limiting example of the operation of the bi-stable solenoid 100 will be described below with reference to FIGS. 1 and 2. It should be appreciated that the described operation of the bi-stable solenoid 100 can be adapted to many suitable systems. In operation, the wire coil 172 of the bi-stable solenoid 100 may be selectively energized (i.e., supplied with a current in a desired direction at a predetermined magnitude), and, in response to the current being applied to the wire coil 172, the armature 112 can move between two stable positions depending on the direction of the current applied to the wire coil 172. In the illustrated non-limiting example, the armature 112 may be movable between a first stable position (see, e.g., FIG. 1), where the armature 112 is arranged adjacent the first portion 136 of the first pole piece 106, and a second stable position (see, e.g., FIG. 2) where the armature 112 contacts or engages the engagement surface 164 of the second pole piece 110.

In one example of operation, the armature 112 may be in the first stable position, as shown in FIG. 1, and the wire coil 172 of the bi-stable solenoid 100 may be energized with a current in a first direction. The armature 112 may then displace (i.e., actuate) toward the second stable position until the armature 112 engages the engagement surface 164 of the second pole piece 110, at which point the armature 112 is in the second stable position, and the wire coil 172 may be de-energized (i.e., the current is removed and the armature 112 is in a stable position). The armature 112 may be held in the second stable position by a magnetic latch, and it will remain in the second stable position until the wire coil 172 is energized with a current in a second direction opposite to the first direction with a magnitude sufficient to overcome the magnetic latch.

Generally, a magnetic latch may be formed by magnetic engagement between two magnetic components and/or two components that are capable of conducting or generating magnetic flux. In the illustrated example, the magnetic latch is established by the permanent magnet 114, which generates a permanent magnetic field that results in magnetic engagement between the armature 112 and the second pole piece 110. Specifically, if the current is of sufficient magnitude to overcome a magnetic attraction between the permanent magnet 114 and the first pole piece 106, the magnetic flux path generated by the energization of the wire coil 172 interacts with the magnetic flux path generated by the permanent magnet 114 to overcome a magnetic attraction between the permanent magnet 114 and the first pole piece 106 and displace the armature 112 axially toward the second pole piece 110 (e.g., downward from the perspective of FIGS. 1 and 2). The balance of the forces generated by the wire coil 172, the magnetic attraction between the permanent magnet 114 and the first pole piece 106, and the magnetic attraction between the permanent magnet 114 and the second pole piece 110 determines a net force on the armature 112. If the force generated by the wire coil 172 is sufficient to displace the armature 112 to the second pole piece 110 and the wire coil 172 is subsequently de-energized, the armature 112 will engage and magnetically latch to the second pole piece 110. Specifically, the armature 112 engages the engagement surface 164 of the second pole piece 110 and the magnetic attraction between the permanent magnet 114 and the second pole piece 110 generates a force on the armature 112 (e.g., in a downward direction from the perspective of FIG. 2) to maintain the armature 112 in the second stable position when the wire coil is de-energized.

When (or as) the wire coil 172 is energized with current in the second direction, the electromagnetic force generated on the armature 112 by the energization of the wire coil 172 may overcome the magnetic attraction between the armature 112 and the second pole piece 110 provided by the permanent magnet 114, and the armature 112 may then displace back to the first stable position. Specifically, if the current is of sufficient magnitude to overcome a magnetic latch between the permanent magnet 114 and the second pole piece 110, the magnetic field generated by the energization of the wire coil 172 interacts with the magnetic field generated by the permanent magnet 114 to overcome a magnetic attraction between the permanent magnet 114 and the second pole piece 110 and displace the armature 112 axially toward the first pole piece 106 (e.g., upward from the perspective of FIGS. 1 and 2). If the force generated by the wire coil 172 is sufficient to displace the armature 112 to the first stable position where the armature 112 engages the stop surface 179 and the wire coil 172 is subsequently de-energized, the armature 112 will be held in place by a magnetic detent formed between the first pole piece 106 and the permanent magnet 114. With the armature 112 being maintained in the first stable position by the magnetic detent and the second stable position by the magnetic latch, the operation of the bi-stable solenoid 100 may require a reduced energy input because the wire coil 172 does not require continuous energization to maintain the armature 112 in either one of the first or second stable positions.

Generally, the armature 112 may be held in each of the first stable position and the second stable position by magnetic flux paths generated by the permanent magnet 114. More specifically, FIG. 2 illustrates the flux path generated by the permanent magnet 114 when the armature 112 held in the second stable position by the magnetic latch and the wire coil 172 is de-energized. In this position, for example, a latch flux path, which is shown by flux lines, travel along paths that is the same as a magnetic path traversed by flux generated by the wire coil 172, when energized. In other words, the second stable position may be established by the latch flux path of the permanent magnet 114 traversing a magnetic flux path that is traversed by flux of the wire coil 172 when energized, which may be referred to as a wire coil flux path. The wire coil flux path may form a loop through the housing 104, the first pole piece 106, the armature 112, the second pole piece 110, and the mounting base 126. Consequently, when the armature 112 is in the second stable position, it is magnetically secured in the second stable position by the flux generated by the permanent magnet 114, which traverses the wire coil flux path to establish the magnetic latch. Further, the magnetic latch may create a force between the armature 112 and the second pole piece 110 that is configured to axially restrain the armature 112 in the second stable position against forces on the armature 112 in an axial direction toward the first stable position that are less than the magnetic attraction between the armature 112 and the second pole piece 110.

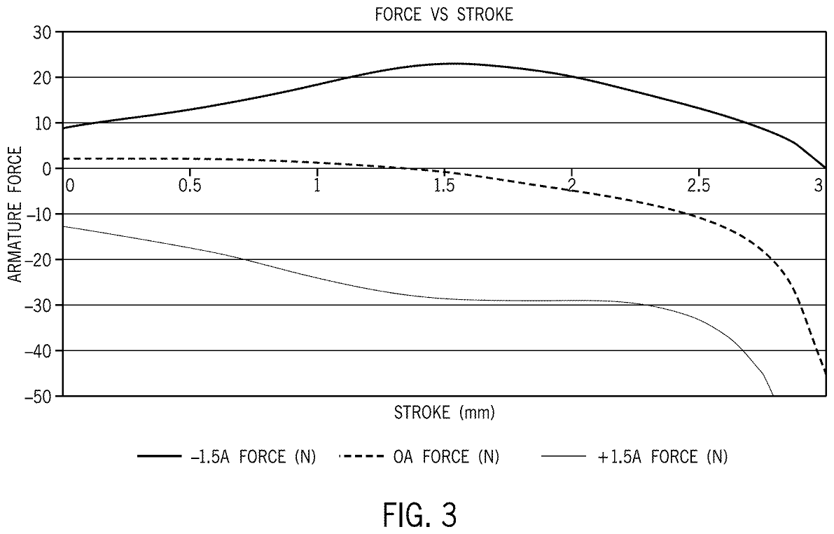

In some non-limiting examples, a magnetic latch may be characterized by a force vs. stroke profile that defines an asymptotic or exponential relationship at or near the location of the magnetic latch. For example, as illustrated in FIG. 3, when the wire coil 172 is de-energized (0 A Force), the force on the armature 112 exponentially increases in the downward direction (negative force represents a force on the armature 112 in the extend direction, or the downward direction from the perspective of FIGS. 1 and 2) as the armature 112 displaces toward the magnetic latch position (increasing in stroke on the graph of FIG. 3).

Returning to FIG. 1, in the first stable position the armature 112 is secured in place by way of a magnetic detent. Generally, a magnetic detent on a solenoid is a location of minimum reluctance. As will be described further below, the magnetic detent may establish a restoring force for biasing an axial position of the armature 112 toward the point of minimum reluctance, i.e., the magnetic detent. The restoring force can be a bi-directional force directed toward an axial center of the detent that is configured to axially bias the armature 112 toward the magnetic detent. Accordingly, at a center of the detent, i.e., the location of minimum reluctance, the restoring force is approximately zero. However, the bi-stable solenoid 100 leverages the force profile generated by the magnetic detent to hold the armature off the axial center of the magnetic detent, so that a force is generated on the armature 112 that holds the armature 112 in the first stable position. With respect to the magnetic detent of the illustrated non-limiting example, a majority of the flux generated by the permanent magnet 114 changes its path when the armature 112 is in the first stable position, so that a majority of the flux travels through the first pole piece 106, as shown by flux lines. That is, the permanent magnet 114 shorts a majority of its flux through the first pole piece 106 by forming a closed-loop flux path that travels through the armature 112, the permanent magnet 114, and the first pole piece 106. The shorted flux of the permanent magnet 114 a force between the armature 112 and the first pole piece 106, so that the force restores the armature 112 toward the first stable position if the armature 112 is pushed away from the first stable position (e.g., a force profile of a magnetic detent).

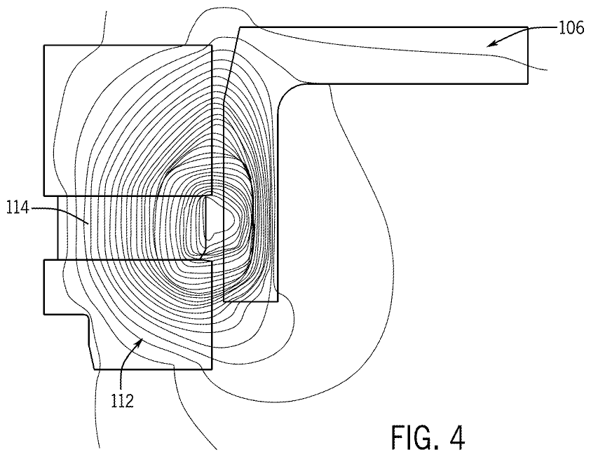

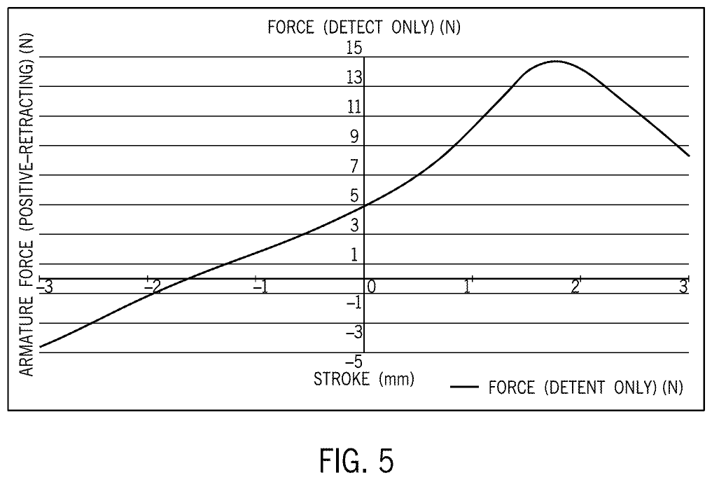

As discussed above, the magnetic detent may establish a restoring force between the armature 112 and the first pole piece 106 that is configured to axially restrain the armature 112 in the first stable position. For example, FIGS. 4 and 5 illustrate the magnetic flux (FIG. 4) and the force vs. stroke profile (FIG. 5) of a magnetic detent, with no other components present (i.e., the balancing force provided by the magnetic latch and from energization of the coil are not accounted for). In the illustrated non-limiting example, the magnetic detent defines a center (i.e., a location of zero force) between a stroke of −1 mm and −2 mm. If the armature 112 is displaced away from this location, the force on the armature 112 increases in a direction that urges the armature 112 back toward the center.

The bi-stable solenoid 100 leverages the characteristics of the force profile generated by the magnetic detent to form the first stable position. For example, the stop surface 179 is arranged at an axial position where restoring force of the magnetic detent urges the armature 112 into the first stable position. In other words, the stop surface 179 is arranged at an axial location that prevents the armature 112 from reaching the center position defined by the magnetic detent, which prevents the armature 112 from reaching the center position and the magnetic detent will thereby generate a force on the armature 112 that urges the armature 112 into the stop surface 179 (i.e., the flux of the permanent magnet 114 that shorts through the first pole piece 106 generates a force that holds the armature 112 against the stop surface 179). In the non-limiting example of FIG. 5, the stop surface 179 may hold the armature 112 at a stoke of zero, where the magnetic detent generates a positive force on the armature 112 (e.g., a positive force retracts the armature 112 into the housing 104 or is in the upward direction from the perspective of FIG. 1). Because the other components of the bi-stable solenoid 100 are not accounted for in the example model of the magnetic detent of FIGS. 4 and 5, the forces illustrated will be higher than in the bi-stable solenoid 100 due to the balancing force of the magnetic latch (e.g., some of the flux generated by the permanent magnet 114 will still travel through the second pole piece 110, but the net force on the armature 112 in the first stable position is still in the upward direction from the perspective of FIG. 1). For example, as illustrated in FIG. 3, when the wire coil 172 is de-energized (0 A Force), the force on the armature 112, the force on the armature 112 at zero stroke (i.e., the first stable position) is positive, which maintains the armature 112 in the first stable position). This positive force is generated because the stop surface 179 holds the armature 112 off of the center position of the magnetic detent, which maintains a force on the armature 112 in an axial direction away from the second pole piece 110. In other words, a force generated by the flux of the permanent magnet 114 shorting through the first pole piece 106 at the location where the stop surface 179 holds the armature 112 in the first stable position is in a direction that is axially away from the second pole piece 110. In this way, for example, the bi-stable solenoid 100 is able to maintain the first and second stable positions, in a de-energized state, without the use of additional biasing components (e.g., a spring).

In addition to the bi-stable performance provided by design of the bi-stable solenoid 100, the force vs. stroke profiles illustrated in FIG. 3 are also provide performance benefits. For example, the energized force-stroke profiles (+1.5 A and −1.5 A curves) define very different shapes near the respective end positions (the left side and the right side of the graph). The energized force (+1.5 A curve) at the detent side (i.e., the left side of the graph near zero stroke), in a direction toward the latch side (i.e., moving from left to right on the graph) is in excess of 10N, absolute value. This force continuously builds in absolute value as the stroke of the armature 112 increases toward the latch side. The force-stoke profile for the equal but opposite current (+1.5 A) is different and not symmetric to its opposite current polarity. Specifically, the −1.5 A force at the latch end acting in a direction toward the detent side (from right to left on the graph) is approximately zero and, as the armature 112 moves toward the detent position (near zero stroke) the energized force decreases in magnitude, rather than increases, like the opposite polarity. In other words, the force-stroke profiles for equal magnitude but opposite current polarities are non-symmetric about the stroke axis. Energization of the wire coil 172 with a first current polarity (e.g., +1.5 A) defines a first force-stroke profile that, when moving from the detent toward the latch position, initially increases in force (absolute value) and then decreases increases in force (absolute value) after the armature 112 moves past an inflection point on the force-stroke profile (e.g., near 1.5 mm stroke). Unlike the first current polarity, energization of the wire coil 172 with a second current polarity that is equal but opposite to the first current polarity (e.g., −1.5 A) defines a second force-stroke profile that, when moving from the detent toward the latch position, increases in force to the inflection point defined by the first polarity and then continues to increase as the stroke increases toward the latch position.

Existing bi-stable solenoid designs tend to employ either separate coil bays, which are selectively bridged by the armature to generate dual latch circuits, or a single coil bay with a single magnetic latch circuit and a biasing return spring. The separated coil-bay design is beneficial because its latch is not hindered by the force of a compressed return spring, but it suffers from an inefficient use of either magnet volume or coil volume, depending on the construction. The single-bay designs have very efficient, high force magnetic circuits, but their latch force is lessened by the return spring which must be sized to provide adequate return force.

Non-limiting examples of the bi-stable design described herein may attempt to combine benefits of existing designs while minimizing the drawbacks. Specifically, non-limiting examples of the present disclosure may have advantages comparable to the dual-bay design in that the stable positions are not necessarily reduced by a spring force. Further, because the magnet is generally part of the coil's flux path, its magnetic field may fully contribute to the force developed. Non-limiting examples herein may also have advantages similar to the single-bay with return spring design. For example, its coil volume may remain unobstructed by shunts or magnets and the resulting additional space required for a bobbin or other insulating media. This aspect may afford the design of a more powerful coil while significantly reducing the complexity over the existing dual-bay design. Additionally, the retracting force may not be limited by a return spring as in the existing single-bay designs.

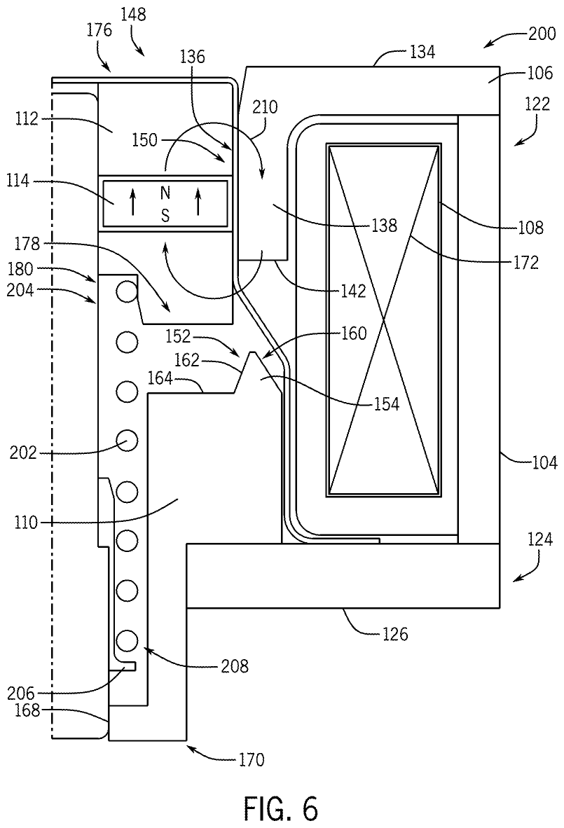

FIGS. 6-8 illustrate a bi-stable solenoid 200 according to another non-limiting example of the present disclosure. The bi-stable solenoid 200 may be similar in design and functionality to the bi-stable solenoid 100 of FIGS. 1 and 2, with similar elements identified using like reference numerals, except as described herein or as apparent from the figures. In general, the bi-stable solenoid 100 does not require the use of a biasing element to establish the stable positions thereof, but the addition of a spring may allow for further stable positions (e.g., more than two stable positions) to be achieved. For example, the bi-stable solenoid 200 includes added elements to establish an additional mid-position. More specifically, the bi-stable solenoid 200 is designed so that the armature 112 may be held in a mid-position, which is between the first stable position and second stable position as described above in connection with the bi-stable solenoid 100. The mid-position is accomplished by incorporating a spring 202 that may be connected to or adjacent the armature 112. Preferably, the spring 202 is disposed adjacent the second end 178 of the armature 112 and configured to provide a biasing force to bias the armature 112 toward the first pole piece 106. In some non-limiting examples, the spring 202 is fixedly attached to the second end 178 of the armature 112 such that a first end 204 of the spring 202 is at least partially disposed within the spring-receiving recess 180 of the armature 112. The spring 202 may be attached to the armature 112 via adhesive, fasteners, bendable tabs, threads, or the like at the first end 204 of the spring 202. The spring 202 may axially extend from the second end 178 of the armature 112 toward the second pole piece 110 to a spring stop 206. The spring stop 206 may be fixedly attached to a second end 208 of the spring 202.

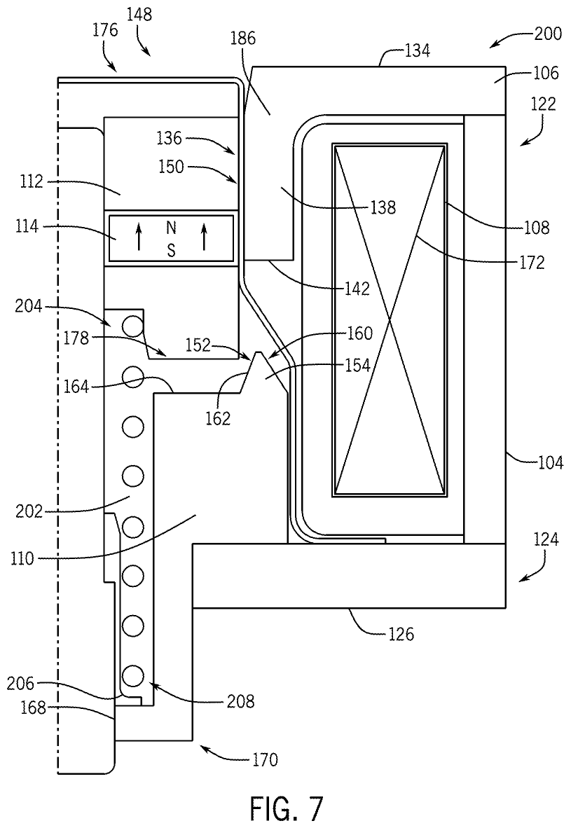

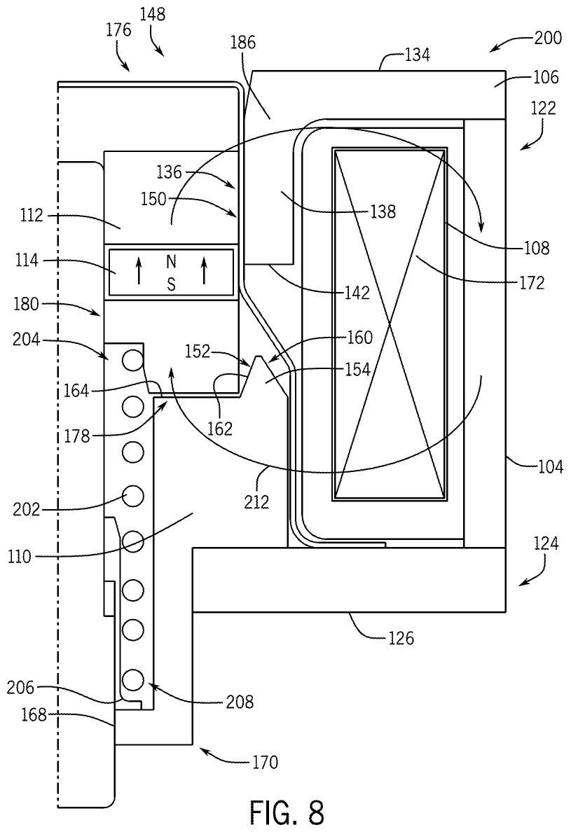

Preferably, with reference to FIG. 6, the spring 202 is configured such that the second end 208 and the spring stop 206 is axially spaced away from the second end 170 of the second pole piece 110 when the armature 112 is in the first position, i.e., the armature 112 is spaced away from the engagement surface 164 of the second pole piece 110. Generally, the spring 202 may be in an at-rest/uncompressed position when the armature 112 is in the first position, i.e., when the armature 112 engages or is adjacent the first pole piece 106 and the flux is shorted through the first pole piece 106 to establish the magnetic detent. When the armature 112 is in the second position, as best seen in FIG. 8, the spring stop 206 may be configured to contact, engage, or be adjacent the second pole piece 110 proximate the second end 170, and the armature 112 may engage or abut the engagement surface 164 of the second pole piece 110. In this way, the spring 202 is compressed between the armature 112 and the second pole piece 110. The bi-stable solenoid 200 according to the illustrated non-limiting example has another stable position, as shown in FIG. 7, in which the armature 112 rests in the mid-position, which is between the first position and the second position. In this mid-position, the spring stop 206 may contact the second pole piece 110, but the spring 202 may remain substantially in the at-rest/uncompressed position. Establishing the mid-position will be described in greater detail below.

A non-limiting example of the operation of the bi-stable solenoid 200 will be described below with reference to FIGS. 6-8. However, it should be appreciated that the described operation of the bi-stable solenoid 200 can be adapted to many suitable systems. In operation, the wire coil 172 of the bi-stable solenoid 200 may be selectively energized (i.e., supplied with a current in a desired direction at a predetermined magnitude), and, in response to the current being applied to the wire coil 172, the armature 112 can move between the three stable positions depending on the direction and magnitude of the current applied to the wire coil 172. In the illustrated non-limiting example, the armature 112 may be movable between the first position (see, e.g., FIG. 6), where the armature 112 engages or is adjacent the first portion 136 of the first pole piece 106, a mid-position (see, e.g., FIG. 7) where the spring stop 206 engages the second pole piece 110 but the spring 202 is not compressed, and the second position (see, e.g., FIG. 8) where the armature 112 contacts or abuts the engagement surface 164 of the armature-receiving recess 162 of the second pole piece 110, and the spring 202 is at least partially compressed.

Still referring to FIG. 6, similar to the bi-stable solenoid 100 shown in FIG. 1, when the armature 112 of the bi-stable solenoid 200 is in the first position, the flux path of the permanent magnet 114 travels through the first pole piece 106, as shown by arrows 210. That is, the flux of the permanent magnet 114 shorts through the first pole piece 106 to generate a magnetic detent and establish a stable position. Therefore, in order to achieve the mid-position, the wire coil 172 must be supplied with an amount of current that can generate a force large enough to overcome the magnetic detent established in the first position but not greater than a preload of the spring 202. The pre-load of the spring 202 thus may keep the armature 112 in the mid-position, i.e., the spring 202 substantially does not compress in the mid-position. Accordingly, in order to achieve the second position, an additional amount of current must be supplied to the wire coil 172 to overcome the preload of the spring 202 and move the armature 112 toward the second pole piece 110. After compressing the spring 202, and the armature 112 moves toward the second pole piece 110, the flux of the permanent magnet 114 may be redirected, as shown by arrows 212. More specifically, the flux of the permanent magnet 114 may travel substantially along the magnetic circuit traversed by a flux path of the wire coil 172, thereby establishing a magnetic latch, as described above with respect to the bi-stable solenoid 100 of FIG. 2. Consequently, when the armature 112 is in the second position, it is magnetically latched in the second position by the flux generated by the permanent magnet 114.

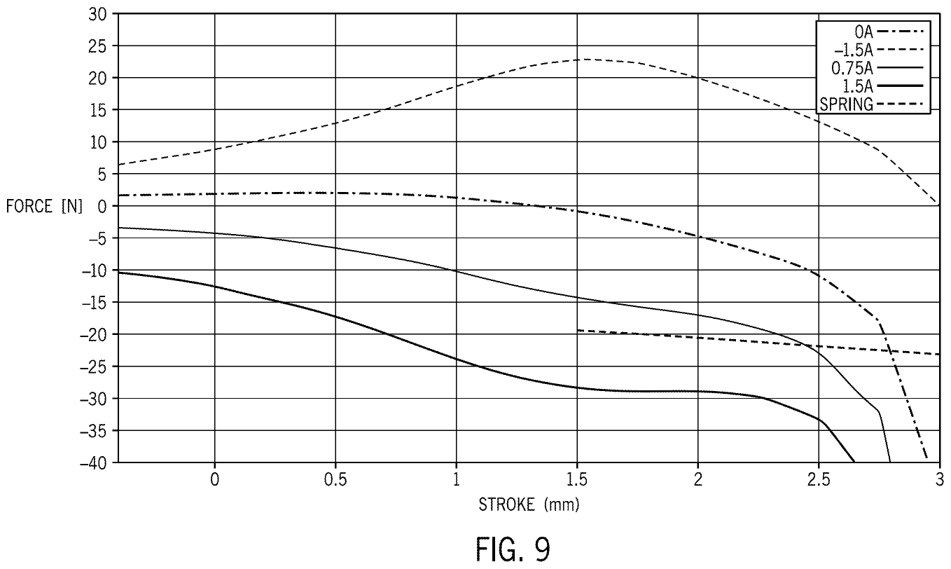

FIG. 9 illustrates one non-limiting example of a force-stroke profile for the bi-stable solenoid 200. In general, to generate a repeatable, energized mid-position within a magnetic circuit that also generates appreciable force, a spring (e.g., the spring 202) is incorporated into the design. This requires the force-stroke profile to build as the spring 202 is compressed and a de-energized holding (latch) force large enough to overcome the fully compressed spring force. Generally, to achieve a stable mid-position, the force vs stroke characteristics of a reluctance based solenoid are required with a stable latch in one direction, and with an unconstrained force-stroke profile towards the retracting direction that is required to break the latch force, fully retract and remain stable once it gets there. The design and properties of the bi-stable solenoid 200 (i.e., magnetic detent, spring, magnetic latch) enable this functionality.

In the illustrated force-stroke graph of FIG. 9, the spring force is shown as being negative, when in application, the force is really acting in a positive direction. The force is illustrated on the negative side of the graph to demonstrate how the spring force splits the −0.75 A and −1.5 A force curves. Based on the force-stroke curves, as long as 0.75 A is applied, it is impossible to push past the start of the spring force at the mid-position (starting at 1.5 mm stroke).

To get to 3 mm stroke (starting at either 0 mm or 1.5 mm), 1.5 A must be applied. Or, to retract back to 0 mm stroke, −1.5 A must be applied. In this design, the compressed spring force also contributes to breaking the latch force.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

We claim:

1. A bi-stable solenoid comprising:
a housing defining a first end and an opposing second end;
a wire coil arranged within the housing;
a first pole piece adjacent the first end of the housing;
a second pole piece adjacent the second end of the housing;
an armature slidably arranged within the housing and movable between a first stable position and a second stable position; and
a permanent magnet arranged within the armature between a first armature portion and a second armature portion, wherein the first armature portion and the second armature portion are fabricated from a magnetically permeable material,
wherein selective energization of the wire coil generates a wire coil flux path and is configured to move the armature between the first stable position and the second stable position, wherein the first stable position is established by magnetic flux of the permanent magnet shorting through the first pole piece, and the second stable position is established by the magnetic flux of the permanent magnet traversing the wire coil flux path.

2. The bi-stable solenoid of claim 1, wherein the armature is adjacent the first pole piece when the armature is in the first stable position.

3. The bi-stable solenoid of claim 1, wherein the magnetic flux of the magnet shorts through the first pole piece by forming a closed loop flux path that travels through the armature, the permanent magnet, and the first pole piece.

4. The bi-stable solenoid of claim 3, wherein, when the magnetic flux of the permanent magnet is shorted through the first pole piece, the magnetic flux of the permanent magnet creates a force between the armature and the first pole piece such that the force restores the armature toward the first stable position if the armature is pushed away from the first stable position.

5. The bi-stable solenoid of claim 1, wherein the armature is adjacent the second pole piece when the armature is in the second stable position.

6. The bi-stable solenoid of claim 5, wherein, when the armature is in the second stable position, the magnetic flux of the permanent magnet creates a force between the armature and the second pole piece such that the force restrains the armature in the second stable position if the armature is pushed away from the second stable position.

7. The bi-stable solenoid of claim 1, further comprising an armature tube arranged at least partially within the housing, wherein the armature tube defines a stop surface that is axially arranged to hold the armature in an axial location where a force generated by the magnetic flux of the permanent magnet shorting through the first pole piece is in a direction that is axially away from the second pole piece.

8. A bi-stable solenoid comprising:
a housing;
a wire coil arranged within the housing;
a first pole piece;
a second pole piece;
an armature including a permanent magnet, wherein the armature is movable between a first stable position and a second stable position; and
an armature tube at least partially encloses the armature and includes a stop surface,
wherein, when the armature is in the first stable position and the wire coil is de-energized, the armature engages the stop surface and a flux of the permanent magnet shorts through the first pole piece by forming a closed loop flux path that travels through the armature, the permanent magnet, and the first pole piece, wherein the stop surface holds the armature in an axial location where the closed loop flux path generates a force on the armature in a direction that urges the armature into the stop surface.

9. The bi-stable solenoid of claim 8, wherein the armature is adjacent the first pole piece when the armature is in the first stable position, and wherein the armature is adjacent the second pole piece when the armature is in the second stable position.

10. The bi-stable solenoid of claim 8, wherein, when the armature is in the second stable position, the flux of the permanent magnet traverses a wire coil flux path that is traversed by flux of the wire coil, when energized, to maintain the second stable position.

11. The bi-stable solenoid of claim 10, wherein, when the armature is in the second stable position, the flux of the permanent magnet creates a force between the armature and the second pole piece such that the force restrains the armature in the second stable position if the armature is forced away from the second stable position.

12. The bi-stable solenoid of claim 8, wherein, when the magnetic flux of the permanent magnet is shorted through the first pole piece, the magnetic flux of the permanent magnet creates a force between the armature and the first pole piece such that the force restores the armature toward the first stable position if the armature is pushed away from the first stable position.

13. The bi-stable solenoid of claim 8, wherein the magnetic flux shorting through the first pole piece in the first stable position establishes a magnetic detent at the first stable position.

14. The bi-stable solenoid of claim 8, wherein the armature includes a first armature portion and a second armature portion, and wherein the first armature portion and the second armature portion are fabricated from a magnetically permeable material.

15. A bi-stable solenoid comprising:
a housing;
a wire coil arranged within the housing;
a first pole piece;
a second pole piece;
an armature including a permanent magnet; and
an armature tube at least partially enclosing the armature and including a stop surface;
wherein selective energization of the wire coil is configured to move the armature between a first position and a second position,
wherein, when the armature is in the first position, flux of the permanent magnet shorts through the first pole piece to establish a magnetic detent, and when the armature is in the second position, the flux of the permanent magnet maintains the armature in the second position with a magnetic latch established by engagement between the armature and the second pole piece, and wherein the stop surface holds the armature in an axial location where the magnetic detent generates a force on the armature in an axial direction away from the second pole piece.

16. The bi-stable solenoid of claim 15, wherein the magnetic detent is established by the magnetic flux forming a closed loop flux path that travels through the armature, the permanent magnet, and the first pole piece.

17. The bi-stable solenoid of claim 15, wherein the magnet detent creates a force between the armature and the first pole piece such that the force restrains the armature in the first position if the armature is pushed away from the first position.

18. The bi-stable solenoid of claim 15, wherein the magnetic latch is established by the flux of the permanent magnet traversing a wire coil flux path traversed by flux of the wire coil, when energized.

19. The bi-stable solenoid of claim 15, wherein the magnetic latch establishes a force between the armature and the second pole piece such that the force restrains the armature in the second position if the armature is forced away from the second position.

20. The bi-stable solenoid of claim 15, wherein the armature includes a first armature portion and a second armature portion, and wherein the first armature portion and the second armature portion are fabricated from a magnetically permeable material.
